(19) United States
(12) Patent Application Publication
(10) Pub. No.: US 2026/0121909 A1
(43) Pub. Date: Apr. 30, 2026

(54) MANAGING CLOUD COMPUTING ENVIRONMENT CLUSTERS

(71) Applicant: Juniper Networks, Inc., Sunnyvale, CA (US)

(72) Inventors: John E. ZIEGLER, Westborough, MA (US); Kathryn L. FULLER, North Reading, MA (US); Steven P. ONISHI, Groton, MA (US); Jonathan AZEVEDO, Watertown, MA (US); Allen WHITEHOUSE HORINE, Cary, NC (US); Michael D. CARR, Riverside, RI (US); Michael ZEIMBEKAKIS, Chelmsford, MA (US)

(21) Appl. No.: 19/350,590

(22) Filed: Oct. 6, 2025

Related U.S. Application Data
(60) Provisional application No. 63/712,035, filed on Oct. 25, 2024.

(51) Int. Cl. H04L 41/0663; H04L 9/40; H04L 67/145

(52) U.S. Cl. CPC H04L 41/0663; H04L 63/166; H04L 67/145

(57) ABSTRACT

A device may receive an indication of a multi-cluster switchover from a first cluster to a second cluster associated with the device, and may generate, based on the multi-cluster switchover, a heartbeat request that includes an information element to be utilized by a user plane device to associate with the device. The user plane device may be associated with the first cluster prior to the multi-cluster switchover. The device may provide the heartbeat request and the information element to the user plane device, and may receive, from the user plane device, a heartbeat response based on the heartbeat request and the information element. The device may establish a secure session with the user plane device based on the heartbeat response.

### CROSS-REFERENCE TO RELATED APPLICATION

This Patent Application claims priority to U.S. Provisional Ser. No. 63/712,035, filed on Oct. 25, 2024, and entitled “MANAGING CLOUD COMPUTING ENVIRONMENT CLUSTERS.” The disclosure of the prior Application is considered part of and is incorporated by reference into this Patent Application.

### BACKGROUND

A cloud cluster is a group of computers or servers that work together as a single system within a virtual private cloud. Clusters are used to deploy applications and services in cloud computing, and they can provide many benefits, such as fault tolerance (e.g., clusters can continue executing if one device fails), load balancing (e.g., clusters distribute traffic across devices to optimize performance), scalability (e.g., clusters may be scaled out by adding or removing devices), performance, and/or the like.

### SUMMARY

Some implementations described herein relate to a method. The method may include receiving an indication of a multi-cluster switchover from a first cluster to a second cluster associated with a device, and generating, based on the multi-cluster switchover, a heartbeat request that includes an information element to be utilized by a user plane device to associate with the device. The user plane device may be associated with the first cluster prior to the multi-cluster switchover. The method may include providing the heartbeat request and the information element to the user plane device, and receiving, from the user plane device, a heartbeat response based on the heartbeat request and the information element.

Some implementations described herein relate to a device. The device may include one or more memories and one or more processors. The one or more processors may be configured to receive an indication of a multi-cluster switchover from a first cluster to a second cluster associated with the device, and generate, based on the multi-cluster switchover, a heartbeat request that includes an information element to be utilized by a user plane device to associate with the device. The user plane device may be associated with the first cluster prior to the multi-cluster switchover. The one or more processors may be configured to provide the heartbeat request and the information element to the user plane device, and receive, from the user plane device, a heartbeat response based on the heartbeat request and the information element. The heartbeat request and the heartbeat response may include packet forwarding control protocol messages.

Some implementations described herein relate to a non-transitory computer-readable medium that stores a set of instructions. The set of instructions, when executed by one or more processors of a device, may cause the device to receive an indication of a multi-cluster switchover from a first cluster to a second cluster associated with the device, and generate, based on the multi-cluster switchover, a heartbeat request that includes an information element to be utilized by a user plane device to associate with the device. The user plane device may be associated with the first cluster prior to the multi-cluster switchover, and the information element may include a controller name, a control plane instance name, and a control plane instance generation number. The set of instructions, when executed by one or more processors of the device, may cause the device to provide the heartbeat request and the information element to the user plane device, and receive, from the user plane device, a heartbeat response based on the heartbeat request and the information element.

### BRIEF DESCRIPTION OF THE DRAWINGS

FIGS. 1A-1I are diagrams of an example associated with managing cloud computing environment clusters.

FIG. 2 is a diagram of an example environment in which systems and/or methods described herein may be implemented.

FIGS. 3 and 4 are diagrams of example components of one or more devices of FIG. 2.

FIG. 5 is a flowchart of an example process for managing cloud computing environment clusters.

### DETAILED DESCRIPTION

The following detailed description of example implementations refers to the accompanying drawings. The same reference numbers in different drawings may identify the same or similar elements.

In a multi-geographic redundancy scheme, there is a first geographical cluster and a second geographical cluster. A management cluster, separate from the first geographical cluster and the second geographical cluster, incorporates multi-cluster orchestration software and application-specific observer software. The multi-cluster orchestration software ensures continuity of workloads across the first geographical cluster and the second geographical cluster. The application-specific observer monitors scheduling events for an application, such as a broadband network gateway (BNG) control and user plane separation (CUPS) controller. The BNG CUPS controller is an application workload that is deployed to the multi-geography, and serves as a control plane component of a disaggregated BNG (DBNG). A control plane instance (CPi) of the BNG CUPS controller interacts with one or more user plane (UP) devices (e.g., network devices) to form the DBNG. The UP devices may be separate from the first geographical cluster and the second geographical cluster.

If a failure occurs in the first geographical cluster, in which the management cluster cannot guarantee continuing operation of an application workload, the management cluster may initiate a switchover procedure of the BNG CUPS controller to the second geographical cluster to ensure continuity of operation. As a result of the switchover, there exists a window of time in which the CPi exists in both the first geographical cluster and the second geographical cluster. A first CPi exists on the failing first geographical cluster and a second CPi exists on the second (about to become first) geographical cluster. The size of the time window depends on the ability of the management cluster to clean up the first CPi. During the time window, the UP devices may receive packet forwarding control protocol (PFCP) messages from the first CPi and the second CPi. The PFCP messages from the second CPi may include PFCP heartbeat messages necessary to begin formation of an association.

In a multi-geographic redundancy scheme, there are at least two orchestration clusters over which an application may be distributed. One orchestration cluster may be considered an active cluster and the other orchestration cluster may be considered a backup cluster. The application may be implemented as a set of containers orchestrated in pods. The application may maintain a configuration in a file written to persistent storage such that the configuration may be recovered after restart of a container or a pod. The application may begin with an initial configuration on the active cluster. In the event of a failure of the active cluster, the application may switch over to the backup cluster. When the application restarts on the backup cluster, the configuration must match a last committed configuration change from the active cluster.

Furthermore, a multi-geographic redundancy scheme may include a management cluster and two or more geographically diverse workload clusters. The management cluster may schedule and monitor application workloads across the available workload clusters. In the event that an application's workload cannot be satisfactorily scheduled and executed on an original workload cluster, the management cluster may reschedule the workload on the remaining available workload clusters and may remove scheduling (e.g., cleanup) of the workload from the original workload cluster. If an original workload cluster becomes isolated from the management cluster, the workload cluster may appear offline to the management cluster. When this occurs, the management cluster may reschedule application workloads to a remaining workload cluster. However, since the original workload cluster is unreachable by the management cluster, workload cleanup cannot occur. As a consequence, the application may have duplicate workloads running on multiple workload clusters. Duplicate workloads create ambiguity with external systems and disrupt normal operation of the application.

Thus, current techniques for managing cloud computing environment clusters consume computing resources (e.g., processing resources, memory resources, communication resources, and/or the like), networking resources, and/or the like, associated with user plane devices receiving PFCP messages from a first CPi and a second CPi, failing to match a configuration of a backup cluster with a last committed configuration change from an active cluster, executing duplicate workloads on multiple workload clusters, creating ambiguity with external systems due to executing duplicate workloads on multiple workload clusters, disrupting normal operation of an application due to executing duplicate workloads on multiple workload clusters, and/or the like.

Some implementations described herein relate to managing cloud computing environment clusters. For example, a device may receive an indication of a multi-cluster switchover from a first cluster to a second cluster associated with the device, and may generate, based on the multi-cluster switchover, a heartbeat request that includes an information element to be utilized by a user plane device to associate with the device. The user plane device may be associated with the first cluster prior to the multi-cluster switchover. The device may provide the heartbeat request and the information element to the user plane device, and may receive, from the user plane device, a heartbeat response based on the heartbeat request and the information element. The device may establish a secure session with the user plane device based on the heartbeat response.

In this way, the device may manage cloud computing environment clusters. For example, the device may seamlessly switchover from a first CPi to a second CPi during a multi-cluster switchover to prevent user plane devices from simultaneously receiving PFCP messages from both the first CPi and the second CPi. The device may also synchronize a configuration of a backup cluster with a last committed configuration of an active cluster, and may prevent duplicate workloads from executing on multiple workload clusters. Thus, the device may ensure that an application operates normally since workloads of the application are executed on a single workload cluster. Thus, the device may conserve computing resources, networking resources, and/or the like that would otherwise have been consumed by user plane devices receiving PFCP messages from a first CPi and a second CPi, failing to match a configuration of a backup cluster with a last committed configuration change from an active cluster, executing duplicate workloads on multiple workload clusters, creating ambiguity with external systems due to executing duplicate workloads on multiple workload clusters, disrupting normal operation of an application due to executing duplicate workloads on multiple workload clusters, and/or the like.

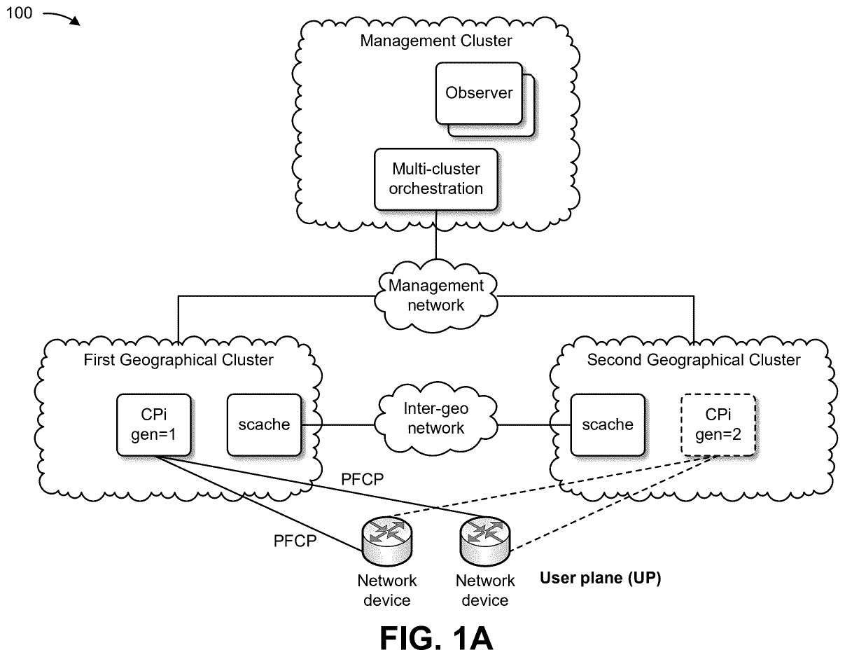

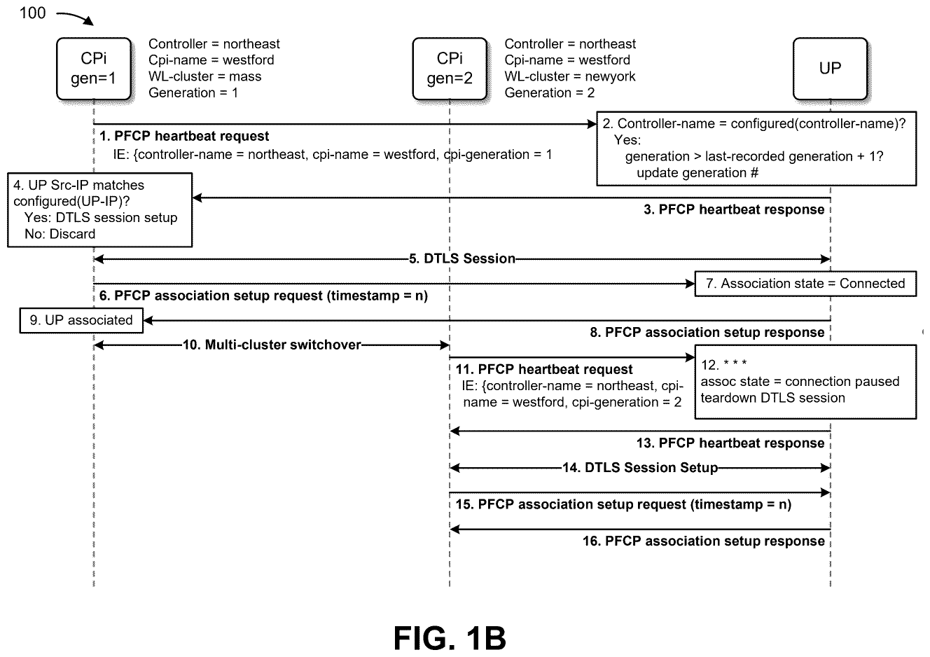

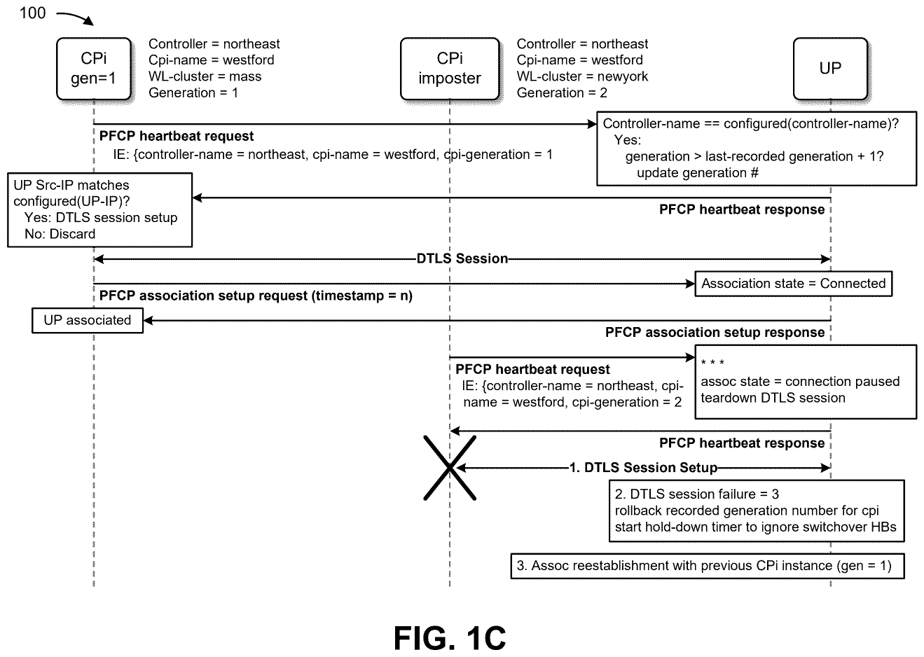

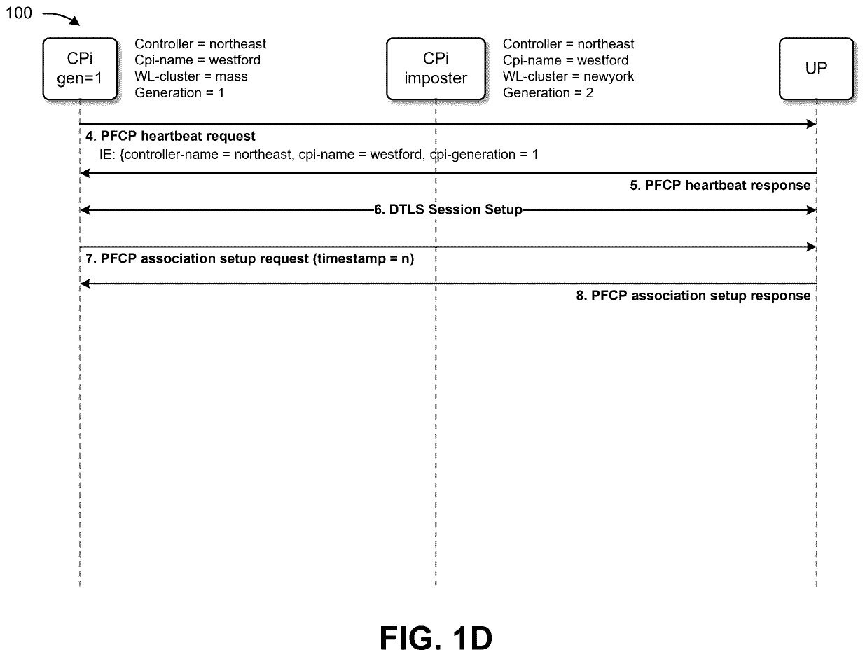

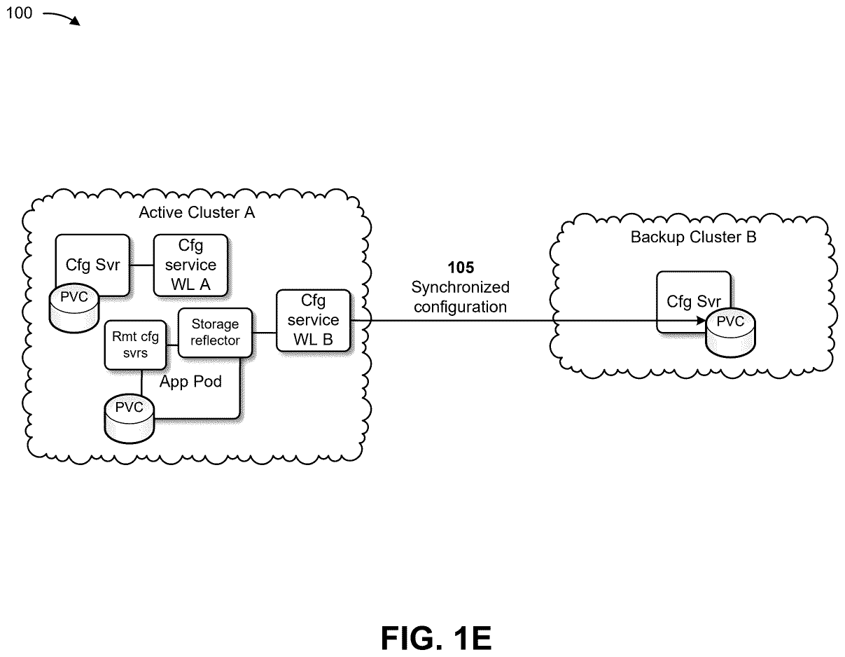

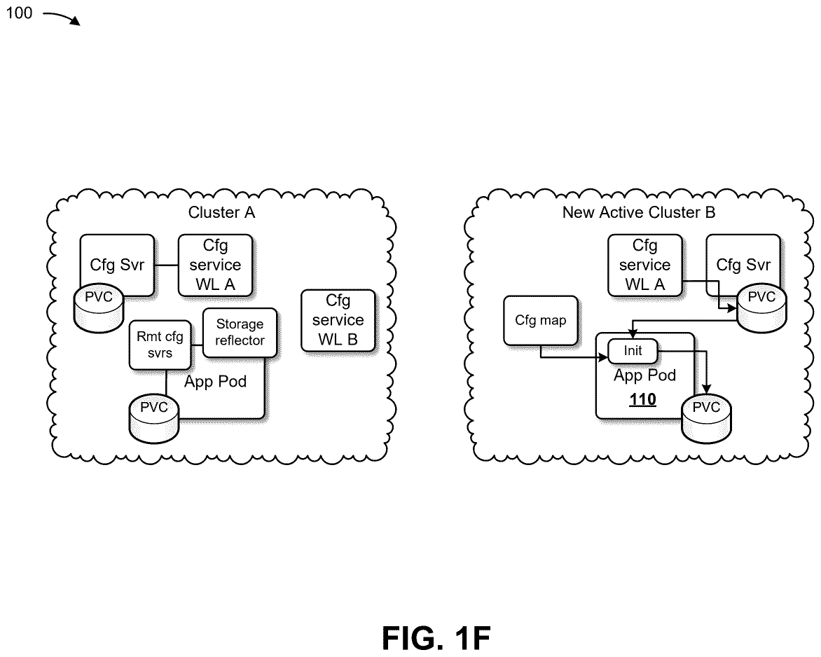

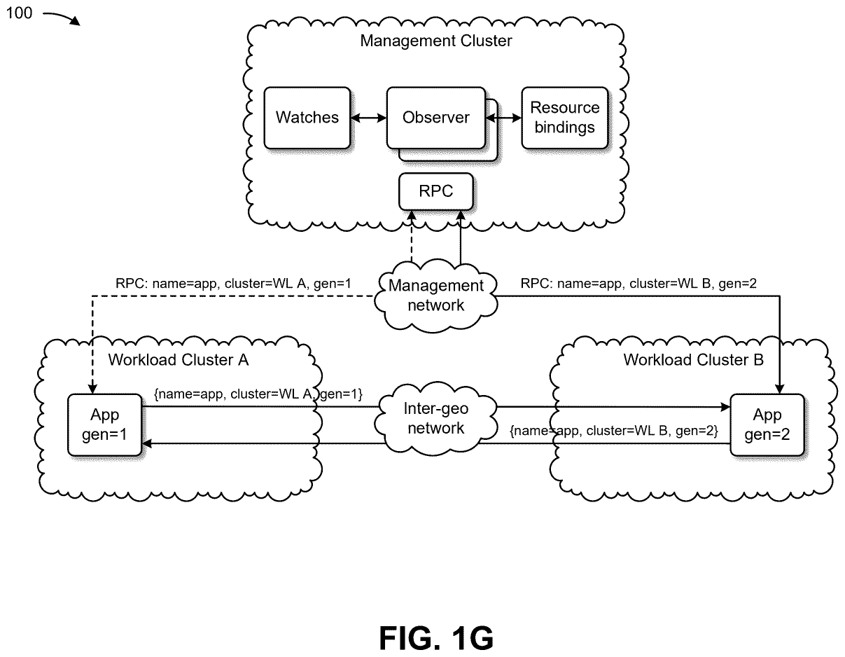

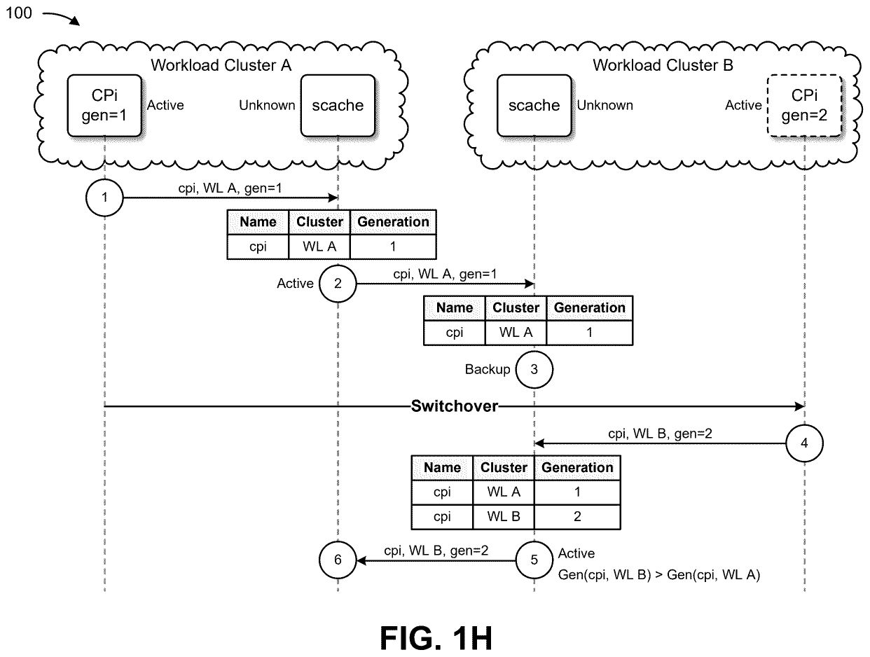

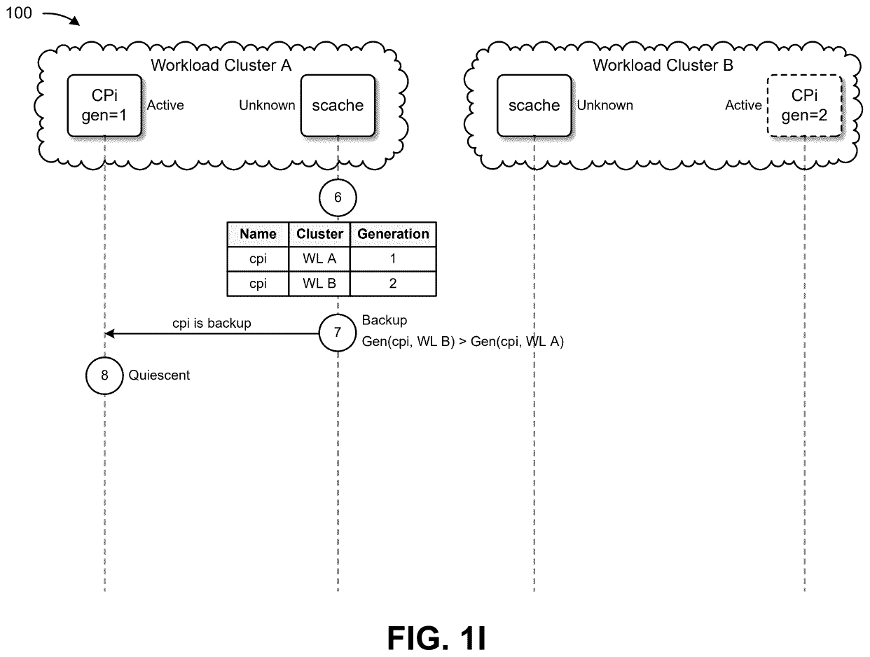

FIGS. 1A-1I are diagrams of an example 100 associated with managing cloud computing environment clusters. As shown in FIGS. 1A-1I, the example 100 includes a management cluster, a first geographical cluster, a second geographical cluster, and UP devices (e.g., network devices). Further details of the management cluster, the first geographical cluster, the second geographical cluster, and the network devices are provided elsewhere herein.

As shown in FIG. 1A, the management cluster may be separate from the first geographical cluster and the second geographical cluster, and may include multi-cluster orchestration software and application-specific observer software. The multi-cluster orchestration software may ensure continuity of workloads across the first geographical cluster and the second geographical cluster. The application-specific observer may monitor scheduling events for an application, such as a BNG CUPS controller. The BNG CUPS controller may include an application workload that is deployed to the multi-geography, and may serve as a control plane component of a DBNG. A CPi of the BNG CUPS controller may interact with one or more UP devices to form the DBNG. The UP devices may be separate from the first geographical cluster and the second geographical cluster.

If a failure occurs in the first geographical cluster, in which the management cluster cannot guarantee continuing operation of an application workload, the management cluster may initiate a switchover procedure of the BNG CUPS controller to the second geographical cluster to ensure continuity of operation. As a result of the switchover, there exists a window of time in which the CPi exists in both the first geographical cluster and the second geographical cluster. A first CPi exists on the failing first geographical cluster and a second CPi exists on the second (about to become first) geographical cluster. The size of the time window depends on the ability of the management cluster to clean up the first CPi. During the time window, the UP devices may receive packet forwarding control protocol (PFCP) messages from the first CPi and the second CPi. The PFCP messages from the second CPi may include PFCP heartbeat messages necessary to begin formation of an association.

As shown in FIG. 1B, a UP device may unambiguously determine with which CPi to associate and consequently with which CPi to tear down any association. The UP device may make these determinations based on an information element (IE) sent with CPi-initiated PFCP heartbeat requests. The IE may include values for a controller name, a CPi name, and a generation number. The controller name and the CPi name may be defined by BNG CUPS controller configuration strings. The generation number may be acquired by the CPi at initialization time from the observer of the management cluster. The generation number may be an integer (e.g., a 32-bit integer) that is unique for each CPi, and may monotonically increase. For example, a CPi initializing in the first geographical cluster may acquire generation of one (1) at initialization time. If the CPi restarts in the first geographical cluster, the CPi may re-acquire the same generation value of one. Upon switchover, the CPi that is created and initialized in the second geographical cluster may acquire a generation number one larger, or two (2).

When the management cluster detects a failure in the first geographical cluster in which a deployed application or workload continuity is not guaranteed, the multi-cluster orchestration software may initiate a switchover procedure. As part of the switchover, a new instance of the CPi may be created on the second geographical cluster. The observer of the management cluster may calculate a new generation number for the new instance of the CPi since the geography is different. In this case, the generation number for the CPi may be two. The newly created instance of the CPi in the second geographical cluster may obtain the generation number during initialization and may establish associations with the set of configured UP devices.

As shown at step 1 of FIG. 1B, association establishment may be made via a PFCP heartbeat request. The first CPi may send the PFCP heartbeat request to the UP device. The PFCP heartbeat request may include the information element that will be utilized by the UP device to associate with the correct instance of the CPi (e.g., the first CPi). For example, as shown, the information element may include a controller name (e.g. northeast), a CPi name (e.g., westford), and a generation number (e.g., 1).

As shown at step 2, a UP device receiving the PFCP heartbeat request from the first CPi may examine the information element to determine whether the controller name is known (e.g., through configuration) and whether the generation number is greater than any recorded generation number for the controller. If the controller is not known and the generation number is not greater than any recorded generation number for the controller, the UP device may generate a PFCP heartbeat response that includes a source network (e.g., Internet protocol (IP)) address of the UP device. As shown at step 3, the UP device may provide the PFCP heartbeat response to the first CPi, and the first CPi may receive the PFCP heartbeat response. As shown at step 4, the first CPi may determine that a datagram transport layer security (DTLS) protocol session is to be established with the UP device based on the PFCP heartbeat response. As shown at step 5, the first CPi may establish the DTLS protocol session with the UP device. As shown at step 6, the first CPi may provide a PFCP association setup request (e.g., with a timestamp=n) to the UP device. As shown at step 7, an association state of the UP device may be set to “connected” based on the PFCP association setup request. As shown at step 8, the UP device may provide a PFCP association setup response to the first CPi. The first CPi may receive the PFCP association setup response and may determine that the UP is associated based on the PFCP association setup response, as shown at step 9.

As shown at step 10 of FIG. 1B, a multi-cluster switchover may occur from the first geographical cluster to the second geographical cluster. As shown at step 11, association establishment may be made via a PFCP heartbeat request. The second CPi may send the PFCP heartbeat request to the UP device. The PFCP heartbeat request may include the information element that will be utilized by the UP device to associate with the correct instance of the CPi (e.g., the second CPi). For example, as shown, the information element may include a controller name (e.g. northeast), a CPi name (e.g., westford), and a generation number (e.g., 2).

As shown at step 12, if the controller is known, an association already exists with this controller, and the offered generation number is one greater than the generation number bound to the existing association (e.g., two is one greater than one), the UP device may tear down the existing association, may record the new generation number, and may begin the process of establishing an association with the second CPi on the second geographical cluster by responding to the PFCP heartbeat request. As shown at step 13, the second CPi may receive a PFCP heartbeat response from the UP device. As shown at step 14, the second CPi on the second geographical cluster may establish a secure (e.g., DTLS protocol) session with the UP device based on receiving the PFCP heartbeat response. As shown at step 15, once secure, the second CPi may send an association setup request using a same timestamp as an original association request from the first CPi on the first geographical cluster. Maintaining the same timestamp in the association enables the UP device to maintain any subscriber state that was established over the association. As shown at step 16, the UP device may provide a PFCP association setup response to the second CPi. Effectively, the information element sent with the PFCP heartbeat request allows the UP device to recognize that the CPi has moved geographies and to resume operation on a new association with the CPi on the second geographical cluster.

As shown in FIGS. 1C and 1D, since the UP device uses the information element in the PFCP heartbeat request to select a CPi with which to associate, a possibility exists for a CPi imposter (e.g., instead of the second CPi described above in connection with FIG. 1B). The initial steps depicted in FIG. 1C are not labeled since they correspond to the steps 1-9 of FIG. 1B. As shown at step 1 of FIG. 1C, the UP device may attempt to establish a secure channel (e.g., the DTLS session) with the CPi imposter, and may fail to establish the secure channel. As shown at step 2, if the UP device cannot establish a secure channel with the CPi within three attempts, the UP device may ignore heartbeat requests with higher generation numbers for a pre-determined hold-down time and may rollback the recorded generation number. As shown at step 3, rolling back the generation number may enable the original association to be re-established and operations to resume with the first CPi.

As shown at step 4 of FIG. 1D, association re-establishment may be made via a PFCP heartbeat request. The first CPi may send the PFCP heartbeat request to the UP device. The PFCP heartbeat request may include the information element that will be utilized by the UP device to associate with the correct instance of the CPi (e.g., the first CPi). For example, as shown, the information element may include a controller name (e.g. northeast), a CPi name (e.g., westford), and a generation number (e.g., 1). As shown at step 5, the UP device may generate a PFCP heartbeat response that includes a source network (e.g., IP) address of the UP device, and may provide the PFCP heartbeat response to the first CPi. The first CPi may receive the PFCP heartbeat response from the UP device. As shown at step 6, the first CPi may establish a secure (e.g., DTLS protocol) session with the UP device based on the PFCP heartbeat response. As shown at step 7, the first CPi may provide a PFCP association setup request (e.g., with a timestamp=n) to the UP device. As shown at step 8, the UP device may provide a PFCP association setup response to the first CPi. The first CPi may receive the PFCP association setup response and may determine that the UP is associated based on the PFCP association setup response.

As shown in FIG. 1E, an active cluster A may be associated with a backup cluster B. The active cluster A may include a configuration server (cfg svr), a configuration service workload A (cfg service WL A), persistent volume claims (PVCs), remote configuration servers (rmt cfg svrs), an application pod (app pod), a storage reflector, and a configuration service workload B (cfg service WL B). The backup cluster B may include a configuration server (cfg svr) and a persistent volume claim (PVC). In some implementations, as shown by reference number 105, a configuration maintained in a persistent storage of the active cluster A may be in synchronization with a configuration maintained in a persistent storage of the backup cluster B such that a latest configuration is available to an application upon a switchover event.

The configuration server may include a server with persistent storage (e.g., the PVC) on each of the active cluster A and the backup cluster B. The configuration servers may utilize public and private keys used for secure transport. The remote configuration servers may include a transport address of the configuration server of the backup cluster B and may include a configuration map. The storage reflector may include a binary value that can be invoked to securely copy a stored configuration file to the configuration server and the PVC of the backup cluster B. The persistent storage may include a location where an application loads an initial configuration.

Upon initial configuration or successful modification to the configuration, the application pod may read the remote configuration server configuration information for details on how to transfer the configuration to the configuration server of the backup cluster B. The details are passed to the storage reflector, which initiates a secure copy to the configuration server of the backup cluster B using the available keys. The application pod may periodically check for any failures in replicating the configuration to the backup cluster B. If a failure is detected, the application pod may reinvoke the storage reflector to retry the secure copy to the configuration server of the backup cluster B. The secure copy may be periodically retried until the configuration is successfully copied to the configuration server of the backup cluster B.

As shown in FIG. 1F, upon application switchover, the application pod is started on the backup cluster B (now the new active cluster), as shown by reference number 110. The application pod's initialization process attempts to securely copy the synchronized configuration from the configuration server's PVC. If a synchronized configuration is recovered, the synchronized configuration may be stored in the PVC to be used as the starting configuration for the application. If no synchronized configuration is recovered, a default and/or factory configuration may be used at application startup.

As shown in FIG. 1G, the management cluster may be associated with a workload cluster A and a workload cluster B. The management cluster executes a part of the application called an observer. The observer monitors scheduling events for application workloads on the workload clusters to compute a generation number. The generation number is incremented each time the application starts on a new workload cluster. At startup, the application on a workload cluster obtains its generation number from its observer through remote procedure call (RPC). The generation number is used to mitigate any leadership ambiguities should the application be in a state where it is present on both workload clusters. The application workload, source cluster, and generation number tuples may be exchanged between the application instances, and a greater generation number may resolve leadership ambiguities.

In some implementations, the watches may be created for application workload components that can be switched over when the components are deployed to a multi-cluster. The observer may listen for the watches in the application. Upon receiving a watch, the observer may subscribe to a matching resource binding that is created when the workload is scheduled on the multi-cluster. Any time there is a change to a watched resource (e.g., rescheduled on a different workload cluster), the resource binding may be updated and a subscription event may be generated and recorded by the observer. A generation number may be calculated based on the observer tracking a watched resource. The generation number may start at one. Each time that a named resource changes workload clusters, the generation number may be monotonically incremented. The observer may make the generation number for watched resources available through the RPC interface. The watched resource, running on a workload cluster, may request a generation number at initialization time. A tuple that includes a workload name, a generation number, and an executing workload cluster may be recorded in an application state that is mirrored to the other workload clusters. In the event that a workload cluster is isolated from the management cluster and the management cluster reschedules the application on a new workload cluster, the rescheduled application may be assigned a generation number that is one larger than a previous incarnation. When two instances of the application are executing on the multi-cluster (one on each of two clusters), the generation number may be used to resolve any ambiguities as to which instance should be the lead or the officially scheduled instance (e.g., the one with the greater generation number).

As shown in FIGS. 1H and 1I, a workload cluster A may include a cache (e.g., a state cache or scache) and a CPi with a generation number of one, and a workload cluster B may include a cache (e.g., a state cache or scache) and a CPi with a generation number of two. As shown at step 1 of FIG. 1H, an application workload and a CPi of the workload cluster A may be assigned a generation number of one that is communicated to the cache. As shown at step 2, a positive generation number for the CPi may trigger transition of the cache state from unknown to an active role for the CPi. As shown at step 3, the workload name, the cluster, and the generation number of the CPi may be replicated to the cache in the workload cluster B, which may trigger state transition from unknown to a backup role. As shown at step 4, at switchover, a new instance of CPi workload may be created on the workload cluster B and may be assigned a generation number of two, which is communicated to the cache of the workload cluster B. At switchover, since an instance of the CPi is created on the workload cluster B, there may be two instances of the CPi executing on the multi-cluster when only one should be active. As shown at step 5, the cache of the workload cluster B may determine that the CPi has a higher generation number, and may transition to an active role for this CPi.

As shown at step 6 of FIG. 1I, the workload name, the cluster, and the generation number of the CPi may be replicated to the cache in the workload cluster A. As shown at step 7 of FIG. 1I, the cache of the workload cluster A may determine that the CPi of the workload cluster B has a greater generation number, and may transition to a backup role for this CPi. As shown at step 8, the cache in workload cluster A may inform the local CPi that the local CPi is now a backup, and the local CPi may cede leadership by becoming quiescent.

In this way, the device may guarantee that only one CPi is active in managing user-plane devices in the multi-geography cluster. For example, the device may seamlessly switchover from a first CPi to a second CPi during a multi-cluster switchover to enable user plane devices to determine an active CPi from which to receive PFCP messages. The device may also synchronize a configuration of a backup cluster with a last committed configuration of an active cluster, and may prevent duplicate workloads from executing on multiple workload clusters. Thus, the device may ensure that an application operates normally since workloads of the application are executed on a single workload cluster. Thus, the device may conserve computing resources, networking resources, and/or the like that would otherwise have been consumed by user plane devices receiving PFCP messages from a first CPi and a second CPi, failing to match a configuration of a backup cluster with a last committed configuration change from an active cluster, executing duplicate workloads on multiple workload clusters, creating ambiguity with external systems due to executing duplicate workloads on multiple workload clusters, disrupting normal operation of an application due to executing duplicate workloads on multiple workload clusters, and/or the like.

As indicated above, FIGS. 1A-1I are provided as an example. Other examples may differ from what is described with regard to FIGS. 1A-1I. The number and arrangement of devices shown in FIGS. 1A-1I are provided as an example. In practice, there may be additional devices, fewer devices, different devices, or differently arranged devices than those shown in FIGS. 1A-1I. Furthermore, two or more devices shown in FIGS. 1A-1I may be implemented within a single device, or a single device shown in FIGS. 1A-1I may be implemented as multiple, distributed devices. Additionally, or alternatively, a set of devices (e.g., one or more devices) shown in FIGS. 1A-1I may perform one or more functions described as being performed by another set of devices shown in FIGS. 1A-1I.

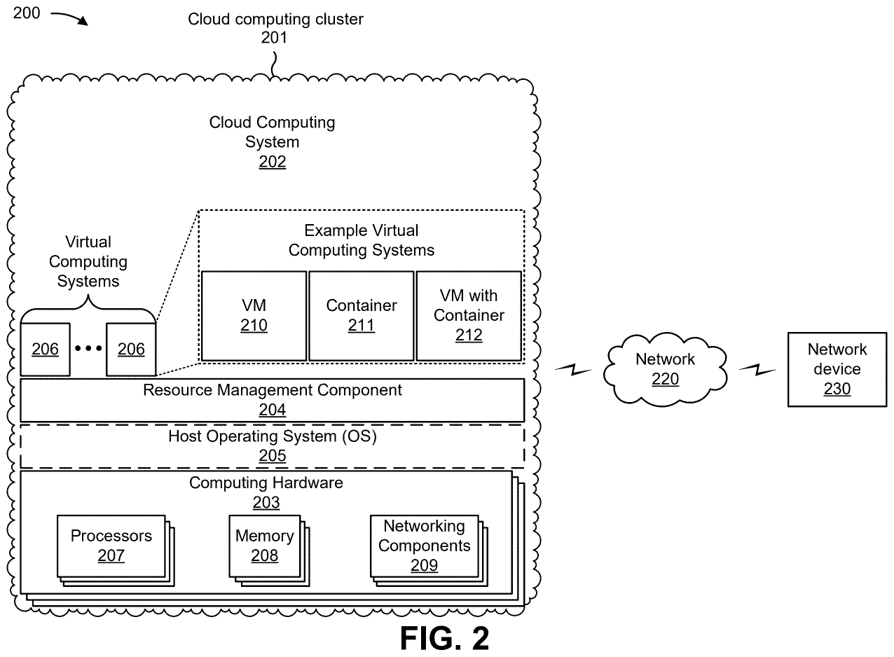

FIG. 2 is a diagram of an example environment 200 in which systems and/or methods described herein may be implemented. As shown in FIG. 2, the environment 200 may include a cloud computing cluster 201, which may include one or more elements of and/or may execute within a cloud computing system 202. The cloud computing system 202 may include one or more elements 203-212, as described in more detail below. As further shown in FIG. 2, environment 200 may include a network 220 and/or a network device 230. Devices and/or elements of the environment 200 may interconnect via wired connections and/or wireless connections.

The cloud computing system 202 may include computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 may include hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, and/or one or more networking components 209. Examples of a processor, a memory, and a networking component (e.g., a communication component) are described elsewhere herein.

The resource management component 204 may include a virtualization application (e.g., executing on hardware, such as the computing hardware 203) capable of virtualizing the computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 210. Additionally, or alternatively, the resource management component 204 may include a container manager, such as when the virtual computing systems 206 are containers 211. In some implementations, the resource management component 204 executes within and/or in coordination with a host operating system 205.

A virtual computing system 206 may include a virtual environment that enables cloud-based execution of operations and/or processes described herein using the computing hardware 203. As shown, a virtual computing system 206 may include a virtual machine 210, a container 211, or a hybrid environment 212 that includes a virtual machine and a container, among other examples. A virtual computing system 206 may execute one or more applications using a file system that includes binary files, software libraries, and/or other resources required to execute applications on a guest operating system (e.g., within the virtual computing system 206) or the host operating system 205.

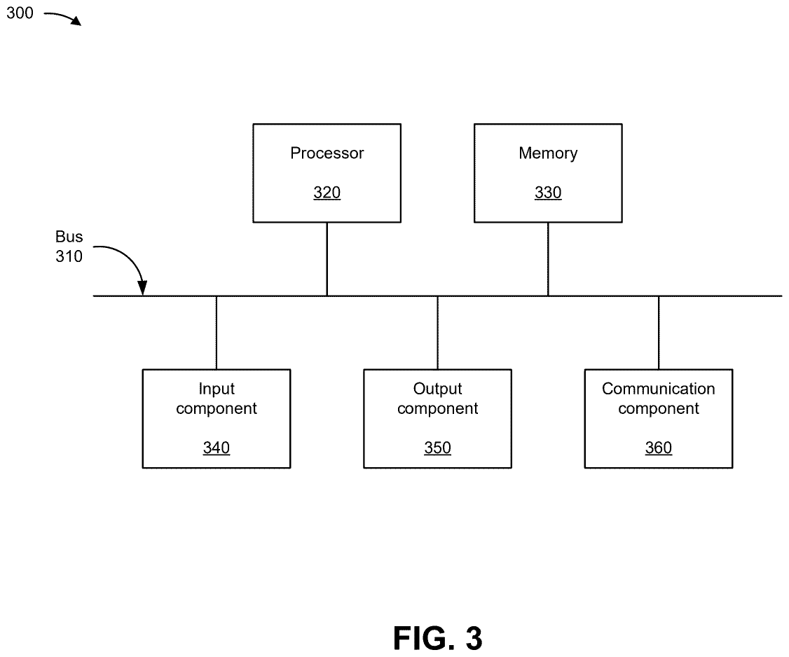

Although the cloud computing cluster 201 may include one or more elements 203-212 of the cloud computing system 202, may execute within the cloud computing system 202, and/or may be hosted within the cloud computing system 202, in some implementations, the cloud computing cluster 201 may not be cloud-based (e.g., may be implemented outside of a cloud computing system) or may be partially cloud-based. For example, the cloud computing cluster 201 may include one or more devices that are not part of the cloud computing system 202, such as device 300 of FIG. 3, which may include a standalone server or another type of computing device. The cloud computing cluster 201 may perform one or more operations and/or processes described in more detail elsewhere herein.

The network 220 includes one or more wired and/or wireless networks. For example, the network 220 may include a packet switched network, a cellular network (e.g., a fifth generation (5G) network, a fourth generation (4G) network, such as a long-term evolution (LTE) network, a third generation (3G) network, a code division multiple access (CDMA) network, a public land mobile network (PLMN)), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The network device 230 includes one or more devices capable of receiving, processing, storing, routing, and/or providing traffic (e.g., a packet or other information or metadata) in a manner described herein. For example, the network device 230 may include a router, such as a label switching router (LSR), a label edge router (LER), an ingress router, an egress router, a provider router (e.g., a provider edge router or a provider core router), a virtual router, a route reflector, an area border router, or another type of router. Additionally, or alternatively, the network device 230 may include a gateway, a switch, a firewall, a hub, a bridge, a reverse proxy, a server (e.g., a proxy server, a cloud server, or a data center server), a load balancer, and/or a similar device. In some implementations, the network device 230 may be a physical device implemented within a housing, such as a chassis. In some implementations, the network device 230 may be a virtual device implemented by one or more computer devices of a cloud computing environment or a data center. In some implementations, a group of network devices 230 may be a group of data center nodes that are used to route traffic flow through the network 220.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of one or more devices of FIG. 2. The example components may be included in a device 300, which may correspond to a node of the cloud computing cluster 201 and/or the network device 230. In some implementations, the cloud computing cluster 201 and/or the network device 230 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit (CPU), a graphics processing unit (GPU), an accelerated processing unit (APU), a microprocessor, a controller, a microcontroller, a digital signal processor (DSP), a field-programmable gate array (FPGA), an application-specific integrated circuit (ASIC), and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

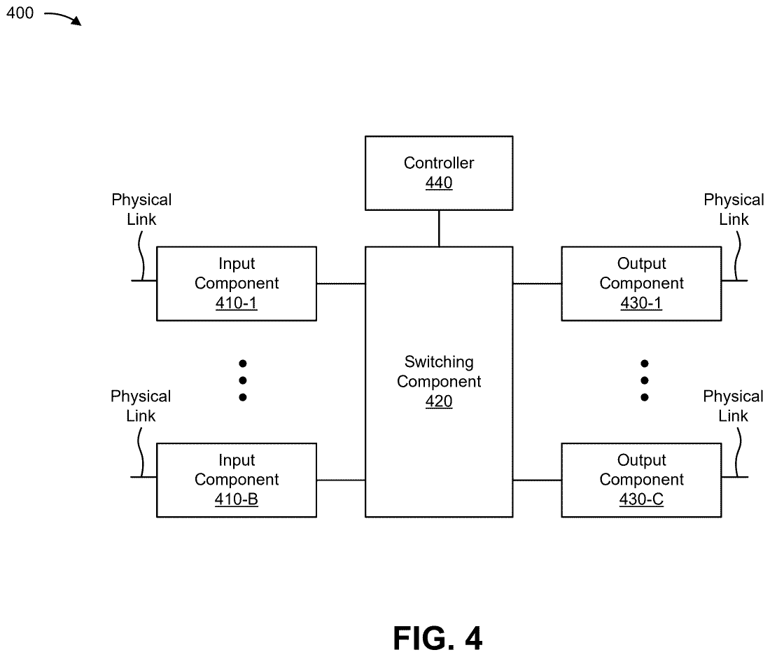

FIG. 4 is a diagram of example components of one or more devices of FIG. 2. The example components may be included in a device 400. The device 400 may correspond to the network device 230. In some implementations, the network device 230 may include one or more devices 400 and/or one or more components of the device 400. As shown in FIG. 4, the device 400 may include one or more input components 410-1 through 410-B (B≥1) (hereinafter referred to collectively as input components 410, and individually as input component 410), a switching component 420, one or more output components 430-1 through 430-C (C≥1) (hereinafter referred to collectively as output components 430, and individually as output component 430), and a controller 440.

The input component 410 may be one or more points of attachment for physical links and may be one or more points of entry for incoming traffic, such as packets. The input component 410 may process incoming traffic, such as by performing data link layer encapsulation or decapsulation. In some implementations, the input component 410 may transmit and/or receive packets. In some implementations, the input component 410 may include an input line card that includes one or more packet processing components (e.g., in the form of integrated circuits), such as one or more interface cards (IFCs), packet forwarding components, line card controller components, input ports, processors, memories, and/or input queues. In some implementations, the device 400 may include one or more input components 410.

The switching component 420 may interconnect the input components 410 with the output components 430. In some implementations, the switching component 420 may be implemented via one or more crossbars, via busses, and/or with shared memories. The shared memories may act as temporary buffers to store packets from the input components 410 before the packets are eventually scheduled for delivery to the output components 430. In some implementations, the switching component 420 may enable the input components 410, the output components 430, and/or the controller 440 to communicate with one another.

The output component 430 may store packets and may schedule packets for transmission on output physical links. The output component 430 may support data link layer encapsulation or decapsulation, and/or a variety of higher-level protocols. In some implementations, the output component 430 may transmit packets and/or receive packets. In some implementations, the output component 430 may include an output line card that includes one or more packet processing components (e.g., in the form of integrated circuits), such as one or more IFCs, packet forwarding components, line card controller components, output ports, processors, memories, and/or output queues. In some implementations, the device 400 may include one or more output components 430. In some implementations, the input component 410 and the output component 430 may be implemented by the same set of components (e.g., and input/output component may be a combination of the input component 410 and the output component 430).

The controller 440 includes a processor in the form of, for example, a CPU, a GPU, an APU, a microprocessor, a microcontroller, a DSP, an FPGA, an ASIC, and/or another type of processor. The processor is implemented in hardware, firmware, or a combination of hardware and software. In some implementations, the controller 440 may include one or more processors that can be programmed to perform a function.

In some implementations, the controller 440 may include a RAM, a ROM, and/or another type of dynamic or static storage device (e.g., a flash memory, a magnetic memory, an optical memory, etc.) that stores information and/or instructions for use by the controller 440.

In some implementations, the controller 440 may communicate with other devices, networks, and/or systems connected to the device 400 to exchange information regarding network topology. The controller 440 may create routing tables based on the network topology information, may create forwarding tables based on the routing tables, and may forward the forwarding tables to the input components 410 and/or output components 430. The input components 410 and/or the output components 430 may use the forwarding tables to perform route lookups for incoming and/or outgoing packets.

The controller 440 may perform one or more processes described herein. The controller 440 may perform these processes in response to executing software instructions stored by a non-transitory computer-readable medium. A computer-readable medium is defined herein as a non-transitory memory device. A memory device includes memory space within a single physical storage device or memory space spread across multiple physical storage devices.

Software instructions may be read into a memory and/or storage component associated with the controller 440 from another computer-readable medium or from another device via a communication component. When executed, software instructions stored in a memory and/or storage component associated with the controller 440 may cause the controller 440 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 4 are provided as an example. In practice, the device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

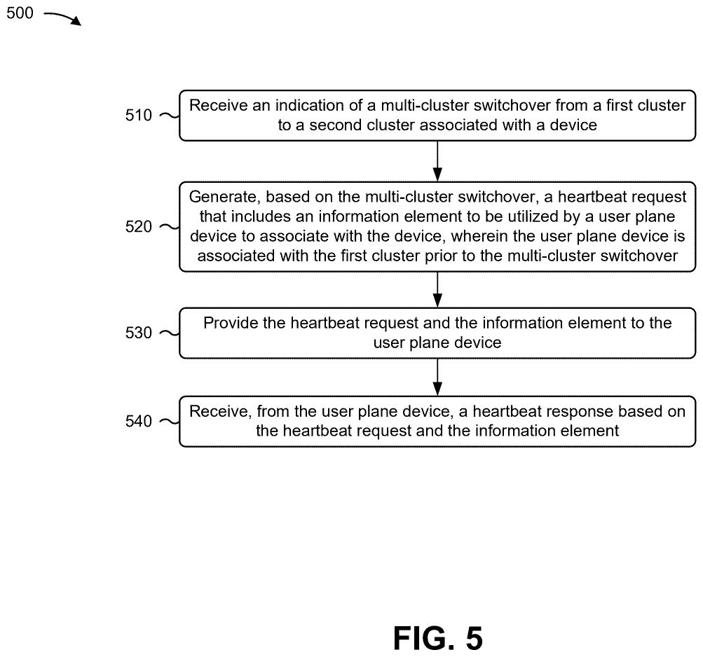

FIG. 5 is a flowchart of an example process 500 for generating customer impact scores associated with network faults. In some implementations, one or more process blocks of FIG. 5 may be performed by a device (e.g., one or more devices of the cloud computing cluster 201). In some implementations, one or more process blocks of FIG. 5 may be performed by another device or a group of devices separate from or including the device, such as a network device (e.g., the network device 230). Additionally, or alternatively, one or more process blocks of FIG. 5 may be performed by one or more components of the device 300, such as the processor 320, the memory 330, the input component 340, the output component 350, and/or the communication interface 360. Additionally, or alternatively, one or more process blocks of FIG. 5 may be performed by one or more components of the device 400, such as the input component 410, the switching component 420, the output component 430, and/or the controller 440.

As shown in FIG. 5, process 500 may include receiving an indication of a multi-cluster switchover from a first cluster to a second cluster associated with the device (block 510). For example, the device may receive an indication of a multi-cluster switchover from a first cluster to a second cluster associated with the device, as described above. In some implementations, the first cluster and the second cluster are geographical clusters. In some implementations, the first cluster becomes a backup workload cluster after the multi-cluster switchover, and the second cluster becomes an active workload cluster after the multi-cluster switchover.

As further shown in FIG. 5, process 500 may include generating, based on the multi-cluster switchover, a heartbeat request that includes an information element to be utilized by a user plane device to associate with the device, wherein the user plane device is associated with the first cluster prior to the multi-cluster switchover (block 520). For example, the device may generate, based on the multi-cluster switchover, a heartbeat request that includes an information element to be utilized by a user plane device to associate with the device, as described above. In some implementations, the user plane device is associated with the first cluster prior to the multi-cluster switchover.

As further shown in FIG. 5, process 500 may include providing the heartbeat request and the information element to the user plane device (block 530). For example, the device may provide the heartbeat request and the information element to the user plane device, as described above. In some implementations, the information element includes a controller name, a control plane instance name, and a control plane instance generation number. In some implementations, wherein the control plane instance generation number causes another device associated with the first cluster to quiesce to the device. In some implementations, the information element causes the user plane device to tear down an association with the first cluster and to establish an association with the second cluster.

As further shown in FIG. 5, process 500 may include receiving, from the user plane device, a heartbeat response based on the heartbeat request and the information element (block 540). For example, the device may receive, from the user plane device, a heartbeat response based on the heartbeat request and the information element, as described above. In some implementations, the heartbeat request and the heartbeat response are PFCP messages.

In some implementations, process 500 includes establishing a secure session with the user plane device based on the heartbeat response. In some implementations, the secure session is a datagram transport layer security protocol session. In some implementations, process 500 includes providing, to the user plane device, an association setup request using a same timestamp as an original association request from the first cluster, and receiving, from the user plane device, an association setup response to the association setup request.

In some implementations, process 500 includes failing to establish a secure session with the user plane device based on the device being an imposter. In some implementations, process 500 includes reestablishing an association with the first cluster based on failing to establish the secure session with the user plane device. In some implementations, process 500 includes receiving, from the first cluster, a synchronized configuration maintained by the first cluster, and utilizing the synchronized configuration after the multi-cluster switchover. In some implementations, process 500 includes one of utilizing the synchronized configuration for an application switchover, or utilizing a default configuration for the application switchover when the synchronized configuration is unavailable.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more. ” Further, as used herein, the article “the” is intended to include one or more items referenced in connection with the article “the” and may be used interchangeably with “the one or more. ” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either”or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method comprising:
receiving, by a device, an indication of a multi-cluster switchover from a first cluster to a second cluster associated with the device;
generating, by the device and based on the multi-cluster switchover, a heartbeat request that includes an information element to be utilized by a user plane device to associate with the device,
wherein the user plane device is associated with the first cluster prior to the multi-cluster switchover;
providing, by the device, the heartbeat request and the information element to the user plane device; and
receiving, by the device and from the user plane device, a heartbeat response based on the heartbeat request and the information element.

2. The method of claim 1, further comprising:
establishing a secure session with the user plane device based on the heartbeat response.

3. The method of claim 2, wherein the secure session is a datagram transport layer security protocol session.

4. The method of claim 2, further comprising:
providing, to the user plane device, an association setup request using a same timestamp as an original association request from the first cluster; and
receiving, from the user plane device, an association setup response to the association setup request.

5. The method of claim 1, wherein the heartbeat request and the heartbeat response are packet forwarding control protocol messages.

6. The method of claim 1, wherein the information element includes a controller name, a control plane instance name, and a control plane instance generation number.

7. The method of claim 6, wherein the control plane instance generation number causes another device associated with the first cluster to quiesce to the device.

8. A device, comprising:
one or more memories; and
one or more processors to:
receive an indication of a multi-cluster switchover from a first cluster to a second cluster associated with the device;
generate, based on the multi-cluster switchover, a heartbeat request that includes an information element to be utilized by a user plane device to associate with the device,
wherein the user plane device is associated with the first cluster prior to the multi-cluster switchover;
provide the heartbeat request and the information element to the user plane device; and
receive, from the user plane device, a heartbeat response based on the heartbeat request and the information element,
wherein the heartbeat request and the heartbeat response are packet forwarding control protocol messages.

9. The device of claim 8, wherein the one or more processors are further to:
fail to establish a secure session with the user plane device based on the device being an imposter.

10. The device of claim 9, wherein the one or more processors are further to:
reestablish an association with the first cluster based on failing to establish the secure session with the user plane device.

11. The device of claim 8, wherein the one or more processors are further to:
receive, from the first cluster, a synchronized configuration maintained by the first cluster; and
utilize the synchronized configuration after the multi-cluster switchover.

12. The device of claim 11, wherein the one or more processors are further to one of:
utilize the synchronized configuration for an application switchover, or
utilize a default configuration for the application switchover when the synchronized configuration is unavailable.

13. The device of claim 8, wherein the first cluster and the second cluster are geographical clusters.

14. The device of claim 8, wherein the first cluster becomes a backup workload cluster after the multi-cluster switchover, and the second cluster becomes an active workload cluster after the multi-cluster switchover.

15. A non-transitory computer-readable medium storing a set of instructions, the set of instructions comprising:
one or more instructions that, when executed by one or more processors of a device, cause the device to:
receive an indication of a multi-cluster switchover from a first cluster to a second cluster associated with the device;
generate, based on the multi-cluster switchover, a heartbeat request that includes an information element to be utilized by a user plane device to associate with the device,
wherein the user plane device is associated with the first cluster prior to the multi-cluster switchover,
wherein the information element includes a controller name, a control plane instance name, and a control plane instance generation number;
provide the heartbeat request and the information element to the user plane device; and
receive, from the user plane device, a heartbeat response based on the heartbeat request and the information element.

16. The non-transitory computer-readable medium of claim 15, wherein the one or more instructions further cause the device to:
establish a secure session with the user plane device based on the heartbeat response;
provide, to the user plane device, an association setup request using a same timestamp as an original association request from the first cluster; and
receive, from the user plane device, an association setup response to the association setup request.

17. The non-transitory computer-readable medium of claim 15, wherein the information element causes the user plane device to tear down an association with the first cluster and to establish an association with the second cluster.

18. The non-transitory computer-readable medium of claim 15, wherein the one or more instructions further cause the device to:
fail to establish a secure session with the user plane device based on the device being an imposter; and
reestablish an association with the first cluster based on failing to establish the secure session with the user plane device.

19. The non-transitory computer-readable medium of claim 15, wherein the one or more instructions further cause the device to:
receive, from the first cluster, a synchronized configuration maintained by the first cluster; and
utilize the synchronized configuration after the multi-cluster switchover.

20. The non-transitory computer-readable medium of claim 19, wherein the one or more instructions further cause the device to one of:
utilize the synchronized configuration for an application switchover, or
utilize a default configuration for the application switchover when the synchronized configuration is unavailable.
